(19) United States
(12) Patent Application Publication
(10) Pub. No.: US 2010/0212315 A1
(43) Pub. Date: Aug. 26, 2010

(54) CONTROL SYSTEM AND CONTROL METHOD FOR VEHICLE

(75) Inventor: Yasuyuki Irisawa, Shizuoka-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, TOYOTA-SHI (JP)

(21) Appl. No.: 12/600,404

(22) PCT Filed: Sep. 25, 2008
(86) PCT No.: PCT/IB08/02492

§ 371 Date: Nov. 16, 2009

(30) Foreign Application Priority Data
Sep. 27, 2007 (JP) 2007-252075

(51) Int. Cl. F02D 23/00; F01L 1/34; F01N 3/10; F01N 9/00

(52) U.S. Cl. 60/602; 123/90.15; 60/299; 60/287

(57) ABSTRACT

A catalyst warm-up control is carried out in a state with a first exhaust valve closed and a second exhaust valve opened. After completion of the catalyst warm-up, if there is an acceleration request, exhaust gas temperature is acquired. If the exhaust gas temperature is equal to or lower than a predetermined value, the second exhaust valve is opened to an intermediate lift to thereby prevent an abrupt drop in exhaust gas temperature. If the exhaust gas temperature is higher than the predetermined value, the second exhaust valve is fully closed to thereby introduce the whole amount of exhaust gas to a turbine. A vehicle control device that achieves both prevention of catalyst deactivation and acceleration performance enhancement can be thus provided.

### BACKGROUND OF THE INVENTION

1. Field of the Invention

The present invention relates to a control system and control method for a vehicle having an internal combustion engine with a turbocharger. More specifically, the present invention relates to achieving both prevention of catalyst deactivation and acceleration performance enhancement.

2. Description of the Related Art

A device is known which includes a first exhaust valve that opens and closes a first exhaust passage leading to a turbine, and a second exhaust valve that opens and closes a second exhaust passage that does not pass through the turbine (independent exhaust engine) (see, for example, Japanese Patent Application Publication No. 10-89106 (JP-A-10-89106)). According to this device, by closing the first exhaust valve and opening the second exhaust valve, exhaust gas can be made to flow while bypassing the turbine, thereby achieving enhanced catalyst warm-up performance. After completion of the catalyst warm-up, by closing the second exhaust valve and opening the first exhaust valve, the whole amount of exhaust gas can be introduced to the turbine, thereby making it possible to meet an acceleration request.

However, in some cases, when the second exhaust valve is closed and only the first exhaust valve is opened in order to meet an acceleration request after completion of catalyst warm-up, this results in an abrupt drop in catalyst bed temperature. In such cases, the catalyst becomes deactivated, which can lead to deterioration in exhaust emission characteristics. Also, in some other cases, water accumulated in the turbocharger and the first exhaust passage during cold operation flows into a sensor and a catalyst downstream of the turbine upon opening only the first exhaust valve. In such cases, the sensor and the ceramic portion of the catalyst become damaged by water, which can cause breakdown of the sensor and the catalyst.

### SUMMARY OF THE INVENTION

The present invention provides a control system and control method for a vehicle which make it possible to achieve both prevention of catalyst deactivation and acceleration performance enhancement.

A first aspect of the present invention relates to a control system for a vehicle having an internal combustion engine with a turbocharger, and includes: a first exhaust valve that opens and closes a first exhaust passage leading to a turbine of the turbocharger; a second exhaust valve that opens and closes a second exhaust passage leading to downstream of the turbine; a variable valve mechanism that makes a lift of the second exhaust valve variable; a catalyst arranged downstream of a junction of the first exhaust passage and the second exhaust passage; and control means for controlling opening and closing of the first and second exhaust valves. When switching from a first state in which the first exhaust valve is closed and the second exhaust valve is opened, to a second state in which the first exhaust valve is opened and the second exhaust valve is closed, the control means interposes a third state in which the first exhaust valve is opened and the second exhaust valve is opened to an intermediate lift within a predetermined range, between the first state and the second state, by using the variable valve mechanism.

In the control system according to the first aspect of the present invention, when switching the valve opening characteristics of the first and second exhaust valves from the first state to the second state, a third state, in which the first exhaust valve is opened and the second exhaust valve is opened to an intermediate lift within a predetermined range, is interposed between the first state and the second state. By opening the second exhaust valve to the intermediate lift in the third state, not the whole amount of exhaust gas flows to the first exhaust passage with a large heat capacity but a part of the exhaust gas is supplied to the catalyst via the second exhaust passage with a small heat capacity. Therefore, it is possible to prevent catalyst deactivation due to an abrupt drop in catalyst bed temperature when switching from the first state to the second state. Also, even when condensed water is accumulated in the first exhaust passage and the turbine in the first state, not the whole amount of exhaust gas flows into the first exhaust passage and the turbine at a time in the third state, so the condensed water can be evaporated in the third state, thereby making it possible to prevent the sensors and the like downstream of the turbine from being damaged by water. Also, by controlling the second exhaust valve to the intermediate lift in the third state, higher acceleration performance can be attained in comparison to the case where the second exhaust valve is controlled to a full lift. Therefore, it is possible to achieve both prevention of catalyst deactivation and acceleration performance enhancement.

Also, the control system according to the first aspect of the present invention may further include exhaust gas temperature acquiring means for acquiring a temperature of exhaust gas that flows into the catalyst, and the control means may control the first and second exhaust valves to the third state when an exhaust gas temperature acquired by the exhaust gas temperature acquiring means is equal to or lower than a predetermined value.

In this way, when the exhaust gas temperature acquired by the exhaust gas temperature acquiring means is equal to or lower than a predetermined value, the first and second exhaust valves are controlled to the third state. In this case, when the first exhaust passage and the turbine have not been warmed up, heat absorption by the first exhaust passage and the turbine is large, so the exhaust gas temperature becomes equal to or lower than a predetermined value. Accordingly, when the exhaust gas temperature is equal to or lower than a predetermined value, that is, until the warm-up of the first exhaust passage and the turbine is completed, the first and second exhaust valves are controlled to the third state, thereby making it possible to prevent an abrupt drop in catalyst bed temperature.

Also, when the exhaust gas temperature is equal to or lower than a predetermined value, the control means may set the intermediate lift of the second exhaust valve smaller as the exhaust gas temperature becomes higher.

In this way, when the exhaust gas temperature is equal to or lower than a predetermined value, the intermediate lift of the second exhaust valve is set smaller as the exhaust gas temperature becomes higher. In this case, as the warm-up of the first exhaust passage and the turbine proceeds, the exhaust gas temperature becomes higher, and the possibility of an abrupt drop in catalyst bed temperature becomes lower. Therefore, by making the intermediate lift of the second exhaust valve small, the acceleration performance can be further enhanced.

Also, the control system according to the first aspect of the present invention may further include: an electric motor as a drive source other than the internal combustion engine; and operating point control-means for controlling an operating point of the internal combustion engine on an iso-output curve along which' a total output of the internal combustion engine and the electric motor is constant, and the operating point control means may control the operating point to a higher rotation side when the first and second exhaust valves are controlled to the third state by the control means, than when the first and second exhaust valves are controlled to the second state.

In this way, when the first and second exhaust valves are controlled to the third state, the operating point of the internal combustion engine on the iso-output curve of the vehicle is controlled to the high rotation side. Since the exhaust gas temperature can be thus increased, the boost pressure can be increased, thereby making it possible to prevent a drop in output in the third state. Further, since the warm-up of the first exhaust passage and the turbine can be promoted, transition to the second state can be made at an early stage, thereby making it possible to enhance the acceleration performance.

Also, when the first and second exhaust valves are controlled to the third state by the control means, the operating point control means may control the operating point to a higher rotation side as the intermediate lift of the second exhaust valve becomes larger.

In this way, when the first and second exhaust valves are controlled to the third state, the operating point of the internal combustion engine is controlled to the higher rotation side as the intermediate lift of the second exhaust valve becomes larger. In this case, the larger the intermediate lift, the smaller the exhaust energy supplied to the turbine. Accordingly, by controlling the operating point of the internal combustion engine to the higher rotation side, the exhaust gas temperature can be increased. Therefore, even when the intermediate lift of the second exhaust valve is large, it is possible to prevent a drop in output, and promote warm-up of the first exhaust passage and the turbine.

A second aspect of the present invention relates to a control method for a vehicle having an internal combustion engine with a turbocharger, and includes: closing a first exhaust valve that opens and closes a first exhaust passage leading to a turbine of the turbocharger, and opening a second exhaust valve that opens and closes a second exhaust passage leading to downstream of the turbine; opening the first exhaust valve, and opening the second exhaust valve to an intermediate lift within a predetermined range by using a variable valve mechanism that makes a lift of the second exhaust valve variable; and opening the first exhaust valve and closing the second exhaust valve, wherein a catalyst is arranged downstream of a junction of the first exhaust passage and the second exhaust passage.

In the control method according to the second aspect of the present invention, when switching the valve opening characteristics of the first and second exhaust valves from the first state to the second state, a third state, in which the first exhaust valve is opened and the second exhaust valve is opened to an intermediate lift within a predetermined range, is interposed between the first state and the second state. By opening the second exhaust valve to the intermediate lift in the third state, not the whole amount of exhaust gas flows to the first exhaust passage with a large heat capacity but a part of the exhaust gas is supplied to the catalyst via the second exhaust passage with a small heat capacity. Therefore, it is possible to prevent catalyst deactivation due to an abrupt drop in catalyst bed temperature when switching from the first state to the second state. Also, even when condensed water is accumulated in the first exhaust passage and the turbine in the first state, not the whole amount of exhaust gas flows into the first exhaust passage and the turbine at a time in the third state, so the condensed water can be evaporated in the third state, thereby making it possible to prevent the sensors and the like downstream of the turbine from being damaged by water. Also, by controlling the second exhaust valve to the intermediate lift in the third state, higher acceleration performance can be attained in comparison to the case where the second exhaust valve is controlled to a full lift. Therefore, it is possible to achieve both prevention of catalyst deactivation and acceleration performance enhancement.

### BRIEF DESCRIPTION OF THE DRAWING

The foregoing and further features and advantages of the invention will become apparent from the following description of example embodiments with reference to the accompanying drawings, wherein like numerals are used to represent like elements, and wherein:

FIG. 1 is a diagram showing a system configuration according to Embodiment 1 of the present invention;

FIGS. 2A and 2B are diagrams showing how valve opening characteristics are switched normally;

FIGS. 3A, 3B, and 3C are diagrams showing how valve opening characteristics are switched according to Embodiment 1 of the present invention;

FIG. 4 is a diagram showing valve opening characteristics in which first and second exhaust valves Ex1, Ex2 are opened to a full lift;

FIG. 5 is a flowchart showing a routine executed by an ECU 80 in Embodiment 1 of the present invention;

FIG. 6 is a diagram illustrating the configuration of a hybrid vehicle according to Embodiment 2 of the present invention;

FIG. 7 is a perspective view showing the main-portion configuration of, a drive mechanism in the hybrid vehicle shown in FIG. 6;

FIG. 8 is a diagram illustrating an engine operating point correction when the second exhaust valve is at an intermediate lift in Embodiment 2 of the present invention; and

FIG. 9 is a flowchart showing a routine executed by the ECU 80 in Embodiment 2 of the present invention.

### DETAILED DESCRIPTION OF EMBODIMENTS

Hereinbelow, an embodiment of the present invention will be described with reference to the drawings. In the drawings, common elements are denoted by the same reference numerals and description thereof is not repeated.

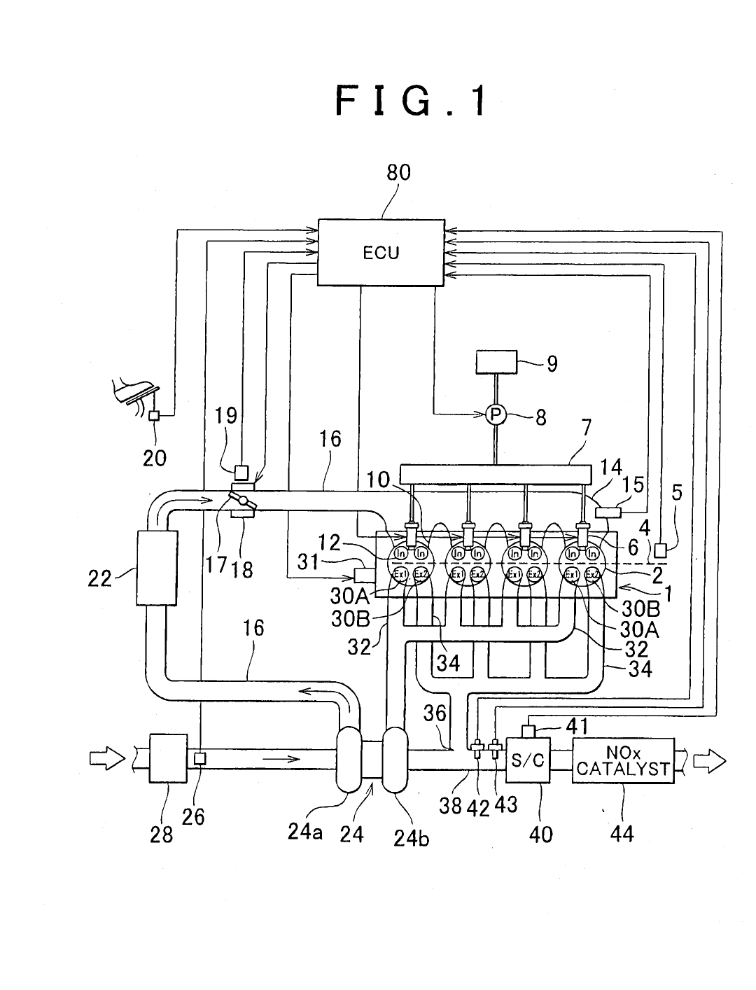

FIG. 1 is a diagram showing a system configuration according to Embodiment 1 of the present invention. A system according to this embodiment is an independent exhaust engine system having a turbocharger. The system shown in FIG. 1 includes an engine 1 having a plurality of cylinders 2. The engine 1 is mounted in a vehicle (not shown). The pistons of the cylinders 2 are each connected to a common crankshaft 4 via a crank mechanism. A crank angle sensor 5 that detects a crank angle CA is provided near the crankshaft 4.

The engine 1 has injectors 6 corresponding to the respective cylinders 2. The injectors 6 are configured to directly inject high-pressure fuel into the cylinders 2. The respective injectors 6 are connected to a common delivery pipe 7. The delivery pipe 7 communicates with a fuel tank 9 via a fuel pump 8.

Also, the engine 1 has intake ports 10 corresponding to the respective cylinders 2. The intake ports 10 are each provided with a plurality of intake valves 12 (sometimes accompanied by symbol “In”). Also, the respective intake ports 10 are connected to an intake manifold 14. The intake manifold 14 is provided with a boost pressure sensor 15. The boost pressure sensor 15 is configured to measure the pressure of air boosted by a compressor 24a described later (hereinafter, referred to as “boosted air”), that is, a boost pressure.

An intake passage 16 is connected to the intake manifold 14. A throttle valve 17 is provided at a position in the intake passage 16. The throttle valve 17 is an electronically controlled valve that is driven by a throttle motor 18. The throttle valve 17 is driven on the basis of an accelerator operation amount AA detected by an accelerator operation amount sensor 20, or the like. A throttle opening sensor 19 is provided near the throttle valve 17. The throttle opening sensor 19 is configured to detect a throttle opening TA. An intercooler 22 is provided upstream of the throttle valve 17. The intercooler 22 is configured to cool boosted air.

A compressor 24a of a turbocharger 24 is provided upstream of the intercooler 22. The compressor 24a is coupled to a turbine 24b via a coupling shaft (not shown). The turbine 24b is provided in a first exhaust passage 32 described later. The compressor 24a is rotationally driven as the turbine 24b is rotationally driven by an exhaust dynamic pressure (exhaust energy).

An airflow meter 26 is provided upstream of the compressor 24a. The airflow meter 26 is configured to detect an intake air amount Ga. An air cleaner 28 is provided upstream of the airflow meter 26.

Also, the engine 1 has a first exhaust valve 30A (sometimes denoted by symbol “Ex1”) and a second exhaust valve 30B (sometimes denoted by symbol “Ex2”) corresponding to each of the cylinders 2. The first exhaust valve 30A opens and closes a first exhaust passage 32 leading to the turbine 24b. The turbine 24b is configured to be rotationally driven by the dynamic pressure of an exhaust circulating through the first exhaust passage 32. Also, the second exhaust valve 30B opens and closes a second exhaust passage 34 leading to downstream of the turbine 24b without passing through the turbine 24b.

A variable valve mechanism 31 that can make the valve opening characteristics (open/close timing and lift) of the second exhaust valve 30B variable is connected to the second exhaust valve 30B. As the variable valve mechanism 31, a known electromagnetically driven valve mechanism, hydraulic or mechanical variable valve mechanism, or the like may be used.

A starting catalyst (S/C) 40 is provided in an exhaust passage 38 downstream of a junction 36 of the first exhaust passage 32 and the second exhaust passage 34. The starting catalyst 40 is provided with a catalyst bed temperature sensor 41 that detects the bed temperature Tsc of the starting catalyst 40. Provided upstream of the starting catalyst 40 in the exhaust passage 38 are an air/fuel ratio sensor 42 that detects an air/fuel ratio, and an exhaust temperature sensor 43 that detects an exhaust gas temperature Tex. Also, provided downstream of the starting catalyst 40 is an NOx catalyst 44 for purifying NOx in exhaust gas.

The system according to Embodiment 1 includes an ECU (Electronic Control Unit) 80 as a control device. Connected to the input side of the ECU 80 are the crank angle sensor 5, the boost pressure sensor 15, the throttle opening sensor 19, the accelerator operation amount sensor 20, the airflow meter 26, the catalyst bed temperature sensor 41, the air/fuel ratio sensor 42, the exhaust temperature sensor 43, and the like. Also, connected to the output side of the ECU 80 are the injector 6, the fuel pump 8, the throttle motor 18, the variable valve mechanism 31, and the like. The ECU 80 computes an engine speed NE on the basis of the crank angle CA. Also, the ECU 80 computes an engine torque TRQ on the basis of the intake air amount Ga, ignition timing, and the like. Also, the ECU 80 carries out an air/fuel ratio control of computing a base fuel injection amount Qbase with respect to the intake air amount Ga so that a target air/fuel ratio (stoichiometric air/fuel ratio) is attained.

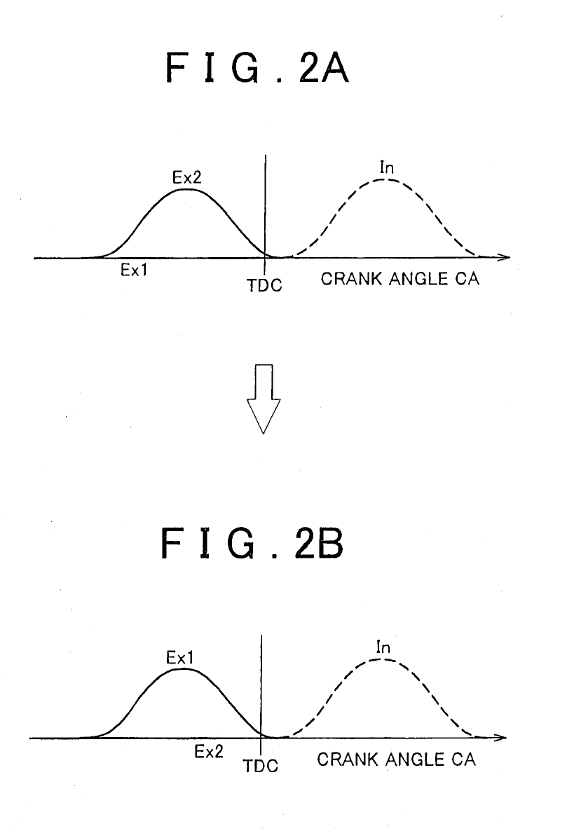

In the independent exhaust engine mentioned above, by closing (stopping) the first exhaust valve Ex1 and opening the second exhaust valve Ex2 as shown in FIG. 2A, exhaust gas can be made to flow while bypassing the turbine 24b. Accordingly, the exhaust heat capacity becomes small, that is, the exhaust heat capacity becomes equivalent to that of a naturally aspirated engine, thus making it possible to enhance the warm-up performance of the starting catalyst 40. Also, by opening the first exhaust valve Ex1 and closing (stopping) the second exhaust valve Ex2 as shown in FIG. 2B, the whole amount of exhaust gas can be introduced to the turbine 24b. The boost pressure can be thus raised for improved turbo response. Therefore, normally, when an acceleration request is made by the vehicle driver through an accelerator operation after completion of the warm-up of the starting catalyst 40, the valve opening characteristics shown in FIG. 2A are switched to the valve opening characteristics shown in FIG. 2B.

However, at start-up (particularly at cold start-up), the first exhaust passage having the turbine 24b with a large heat capacity is in a cold state. Thus, when the valve opening characteristics are simply switched from FIG. 2A to FIG. 2B after completion of the warm-up of the starting catalyst 40, the temperature of exhaust gas flowing into the starting catalyst 40 abruptly drops, which may result in an abrupt drop in the bed temperature Tsc of the starting catalyst 40. If this occurs, the starting catalyst 40 decreases in activity level or eventually becomes deactivated, which can cause a deterioration in exhaust emission characteristics.

Also, it is known that as the turbine 24b cools during cold operation, condensed water accumulates in the turbine 24b and the first exhaust passage 32. When the valve opening characteristics are switched from FIG. 2A to FIG. 2B as mentioned above, a large amount of exhaust gas flows through the first exhaust passage 32 at a time, so the water (exhaust condensed water) accumulated in the turbine 24b and the first exhaust passage 32 comes into contact with the sensors 42, 43, the starting catalyst 40, and the like located downstream thereof. That is, the sensors 42, 43, the starting catalyst 40, and the like located downstream of the turbine 24b are damaged by the water. As a result, a crack develops at the ceramic portion of each of the sensors 42, 43 and the starting catalyst 40, which can cause breakdown.

To avoid the problems of an abrupt drop in bed temperature Tsc, and damage to the sensors 42, 43 and the like by water mentioned above, it is conceivable to execute a gradual change process of gradually increasing the lift (and/or working angle) of the first exhaust valve Ex1. To execute such a gradual change process, it is necessary to separately provide a variable valve mechanism that can make the lift of the first exhaust valve Ex1 variable. However, the lift control of the first exhaust valve Ex1 is not required by other operation performances. That is, all operation performance requirements can be met by a simple open and close operation of the first exhaust valve Ex1. Therefore, even when a variable valve mechanism is added to the first exhaust valve Ex1, this does not provide any gain in terms of other operation performances, so the disadvantage of higher system cost outweighs any potential advantage. Also, during the gradual change period of the first exhaust valve Ex1, the amount of exhaust energy introduced to the turbine 24b becomes short, and a drop in output due to insufficient boost pressure becomes very large, making it impossible to meet the acceleration request. In this regard, in recent years, small-displacement engines with a turbocharger have been developed. In the case of such downsized engines as well, it is essential to meet an acceleration request at partial output. Therefore, the first exhaust valve Ex1 must be fully opened after completion of the warm-up of the starting catalyst 40.

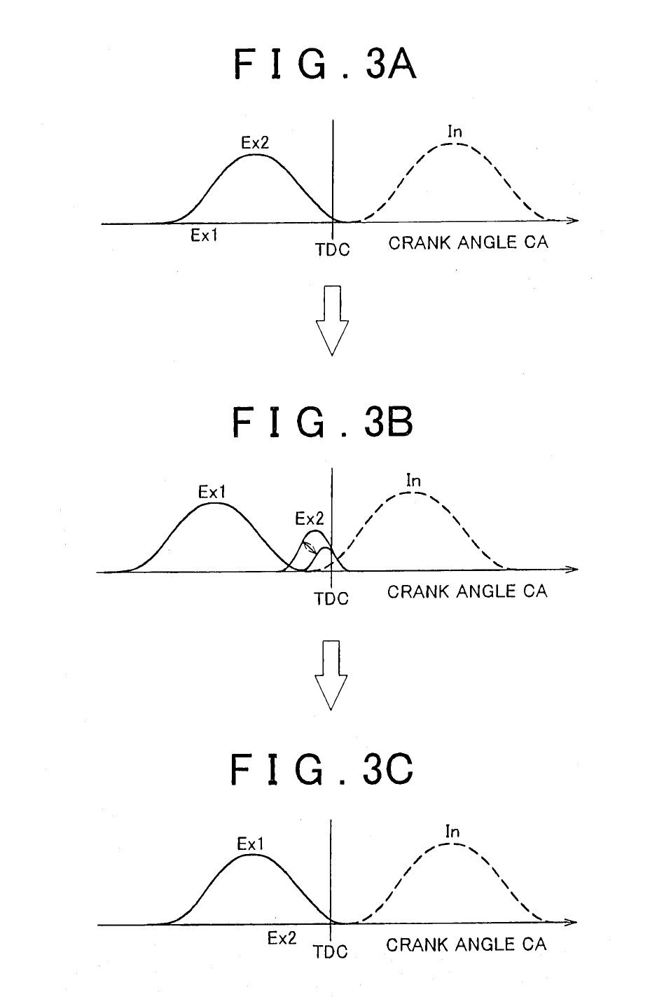

Accordingly, in Embodiment 1, when there is an acceleration request after completion of the warm-up of the starting catalyst 40, the valve opening characteristics are switched as shown in FIGS. 3A to 3C. FIGS. 3A to 3C are diagrams showing how valve opening characteristics are switched according to Embodiment 1. In this case, the valve opening characteristics shown in FIGS. 3A and 3C are the same as the valve opening characteristics shown in FIGS. 2A and 2B. Hence, the main feature of Embodiment 1 resides in interposing the valve opening characteristics shown in FIG. 3B between FIGS. 3A and 3C.

In Embodiment 1, when warm-up of the starting catalyst 40 has not been completed yet, as shown in FIG. 3A, the first exhaust valve Ex1 is closed (stopped) and the second exhaust valve Ex2 is opened. Thus, the whole amount of exhaust gas can be made to flow into the starting catalyst 40 via the second exhaust passage 34 with a small heat capacity. Therefore, the warm-up performance of the starting catalyst 40 can be improved.

When there is an acceleration request after completion of the warm-up of the starting catalyst 40, as shown in FIG. 3B, the first exhaust valve Ex1 is opened to a full lift, and the second exhaust valve Ex2 is opened to an intermediate lift. By opening the first exhaust valve Ex1, the first exhaust passage 32 and the turbine 24b can be warmed up, thereby making it possible to evaporate condensed water produced during cold operation. Further, since the second exhaust valve Ex2 is opened to an intermediate lift, a large amount of exhaust gas is not supplied to the first exhaust passage 32 at a time. Therefore, it is possible to prevent the sensors 42, 43, and the like downstream of the turbine 24b from being damaged by water.

In this case, the intermediate lift of the second exhaust valve Ex2 can be set in accordance with the exhaust gas temperature Tex. That is, the intermediate lift can be set according to the warm-up state of the first exhaust passage 32 and the turbine 24b. In this case, when the degree of progress in the warm-up of the first exhaust passage 32 and the turbine 24b is low, and heat absorption is large, the exhaust gas temperature Tex becomes low. At this time, if the lift of the second exhaust valve Ex2 is reduced, the exhaust gas temperature Tex abruptly drops, which can cause an abrupt drop in the bed temperature Tsc of the starting catalyst 40. Accordingly, when the exhaust gas temperature Tex is low, the lift of the second exhaust valve Ex2 is increased in comparison to when the exhaust gas temperature Tex is high. Then, as the warm-up of the first exhaust passage 32 and the turbine 24b proceeds, the intermediate lift of the second exhaust valve Ex2 is gradually reduced. It should be noted, as described above, that the intermediate lift is controlled within a predetermined range where the sensors 42, 43, and the like is not damaged by water.

Thereafter, when the warm-up of the first exhaust passage 32 and the turbine 24b is completed, it is then assumed that an abrupt drop in the exhaust gas temperature Tex will not occur even if the whole amount of exhaust gas is made to flow to the first exhaust passage 32. Further, at this time, it is assumed that condensed water has evaporated. Thus, when the exhaust gas temperature Tex becomes higher than a predetermined value, it is regarded that the warm-up of the first exhaust passage 32 and the turbine 24b has been completed and, as shown in FIG. 3C, the first exhaust valve Ex1 is opened and the second exhaust valve Ex2 is closed. Thus, the whole amount of exhaust gas can be made to flow to the first exhaust passage 32 for enhanced output, thereby making it possible to meet an acceleration request.

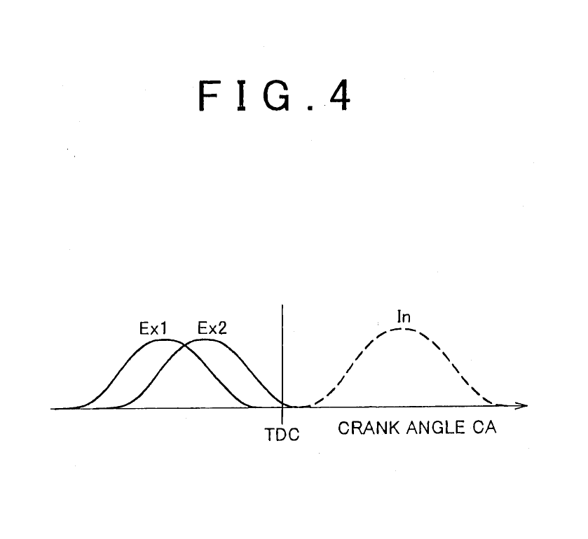

It is conceivable to switch to the valve opening characteristics shown in FIG. 4 after completion of the warm-up of the starting catalyst 40. However, if the second exhaust valve Ex2 is set to a full lift as shown in FIG. 4, the amount of gas supplied to the turbine 24b decreases, resulting in insufficient boost pressure. Thus, by setting the second exhaust valve Ex2 to an intermediate lift as shown in FIG. 3B, enhanced acceleration performance can be achieved in comparison to the case where the second exhaust valve Ex2 is set to a full lift as shown in FIG. 4.

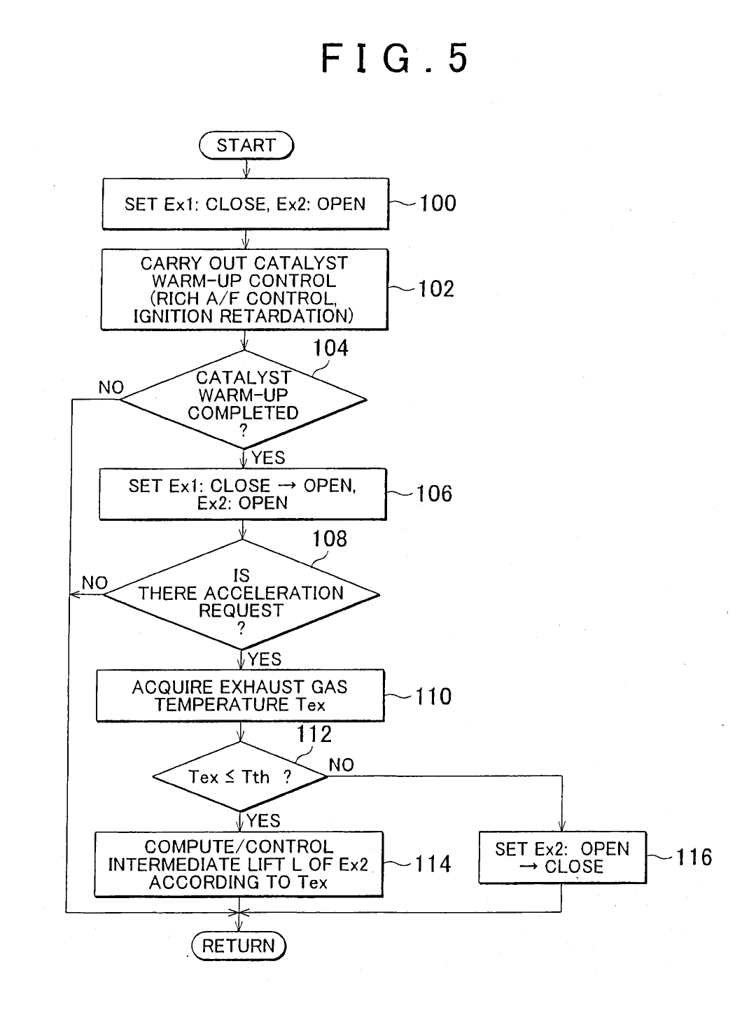

FIG. 5 is a flowchart showing a routine, executed by the ECU 80 in Embodiment 1. The routine shown in FIG. 5 is activated at engine start-up, for example. According to the routine shown in FIG. 5, first, the first exhaust valve Ex1 is closed and the second exhaust valve Ex2 is opened (step 100). In this step 100, as shown in FIG. 3A, the first exhaust valve Ex1 is fully closed (stopped), and the second exhaust valve Ex2 is opened to a full lift.

Thereafter, a catalyst warm-up control is carried out (step 102). In this step 102, for example, a rich air/fuel ratio control of controlling the air/fuel ratio to be richer than stoichiometric, and a control of retarding the ignition timing are carried out.

Next, it is determined whether or not the warm-up of the starting catalyst 40 has been completed (step 104). In this step 104, catalyst warm-up is determined to have been completed if the bed temperature Tsc of the starting catalyst 40 is equal to or higher than a predetermined value (for example, 350° C.). If it is determined in step 104 mentioned above that catalyst warm-up has not been completed yet, the present routine is terminated temporarily.

If, after the present routine is activated next time, it is determined in step 104 mentioned above that catalyst warm-up has been completed, the first exhaust valve Ex1 is opened, and the second exhaust valve Ex is opened (step 106). In this step 106, since whether or not there is an acceleration request is unknown, as shown in FIG. 4, the first and second exhaust valves Ex1 and Ex2 are both set to a full lift.

Thereafter, it is determined whether or not there is an acceleration request (step 108). In this step 108, when the accelerator operation amount AA is equal to or larger than a reference value AAth, it is determined that there is an acceleration request. If it is determined in this step 108 that there is no acceleration request, it is determined that there is no need to raise the boost pressure. In this case, there is no need to reduce the lift of the second exhaust valve Ex2, and the present routine is terminated temporarily. That is, as shown in FIG. 4, the state of opening both the first and second exhaust valves Ex1 and Ex2 at a full lift is maintained.

On the other hand, if it is determined in step 108 mentioned above that there is an acceleration request, the exhaust gas temperature Tex is acquired (step 110). Thereafter, it is determined whether or not the exhaust gas temperature Tex acquired in step 110 mentioned above is equal to or lower than a predetermined value Tth (step 112). This predetermined value Tth is a reference value used for determining whether or not the warm-up of the first exhaust passage 32 and the turbine 24b has been completed.

If it is determined in step 112 mentioned above that the exhaust gas temperature Tex is equal to or lower than the predetermined value Tth, it is determined that the warm-up of the first exhaust passage 32 and the turbine 24b has not been completed. That is, it is determined that if the second exhaust valve Ex2 is fully'closed in this state, the bed temperature Tsc of the starting catalyst 40 abruptly drops, resulting in possible deactivation of the starting catalyst 40. In this case, an intermediate lift L of the second exhaust valve Ex2 according to the exhaust gas temperature Tex acquired in step 110 mentioned above is computed, and the variable valve mechanism 31 is controlled for achieving this intermediate lift L (step 114). In this case, the higher the exhaust gas temperature Tex, the more the warm-up of the first exhaust passage 32 and the turbine 24b has progressed, so it is assumed that there is a low possibility of an abrupt drop in the exhaust gas temperature Tex even when the intermediate lift L is set small. In step 114, the intermediate lift is set smaller as the exhaust gas temperature Tex becomes higher. Thereafter, the present routine is terminated temporarily.

When the present routine is activated thereafter, and it is determined in step 112 mentioned above that the exhaust gas temperature Tex is higher than the predetermined value Tth, it is determined that the warm-up of the first exhaust passage 32 and the turbine 24b has been completed. That is, it is determined that even if the second exhaust valve Ex2 is fully closed in this state, there is a very low possibility of the bed temperature Tsc of the starting catalyst 40 abruptly dropping to cause deactivation of the starting catalyst 40. In this case, as shown in FIG. 3C, the second exhaust valve Ex2 is fully closed (stopped) (step 116). Thereafter, the present routine is terminated.

As described above, according to the routine shown in FIG. 5, at engine start-up, first, the first exhaust valve Ex1 is closed and the second exhaust valve Ex2 is opened to a full lift to implement a catalyst warm-up control. When catalyst warm-up is completed, the first exhaust valve Ex1 is opened to a full lift for enhanced output. Further, if there is an acceleration request, when the exhaust gas temperature Tex is equal to or lower than the predetermined value Tth, the lift of the second exhaust valve Ex2 is controlled to the intermediate lift L. Therefore, it is possible to prevent deactivation of the starting catalyst 40 by taking the warm-up state of the first exhaust passage 32 and the turbine 24b into consideration, and also enhance the acceleration performance. If there is an acceleration request, when the exhaust gas temperature Tex is higher than the predetermined value Tth, there is no fear of deactivation of the starting catalyst 40, so the second exhaust valve Ex2 is fully closed, thereby achieving further acceleration performance enhancement.

While in Embodiment 1 the exhaust gas temperature Tex is detected by the exhaust temperature sensor 43, the exhaust gas temperature Tex may be estimated on the basis of the intake air amount Ga, the ignition timing, and the like.

It should be noted that in Embodiment 1, the turbocharger 24 may be regarded as the “turbocharger” according to the present invention, the engine 1 can be regarded as the “internal combustion engine” according to the present invention, the turbine 24b may be regarded as the “turbine” according to the present invention, the first exhaust passage 32 may be regarded as the “first exhaust passage” according to the present invention, the first exhaust valve Ex1 may be regarded as the “first exhaust valve” according to the present invention, the second exhaust passage 34 may be regarded as the “second exhaust passage” according to the present invention, the second exhaust valve Ex2 may be regarded as the “second exhaust valve” according to the present invention, the variable valve mechanism 31 may be regarded as the “variable valve mechanism” according to the present invention, and the starting catalyst 40 may be regarded as the “catalyst” according to the present invention. Also, in Embodiment 1, the “control means” according to the present invention, and the “exhaust gas temperature acquiring means” according to the present invention are realized by the ECU 80 executing the processing of steps 100, 112, 114, 116, and the processing of step 110, respectively.

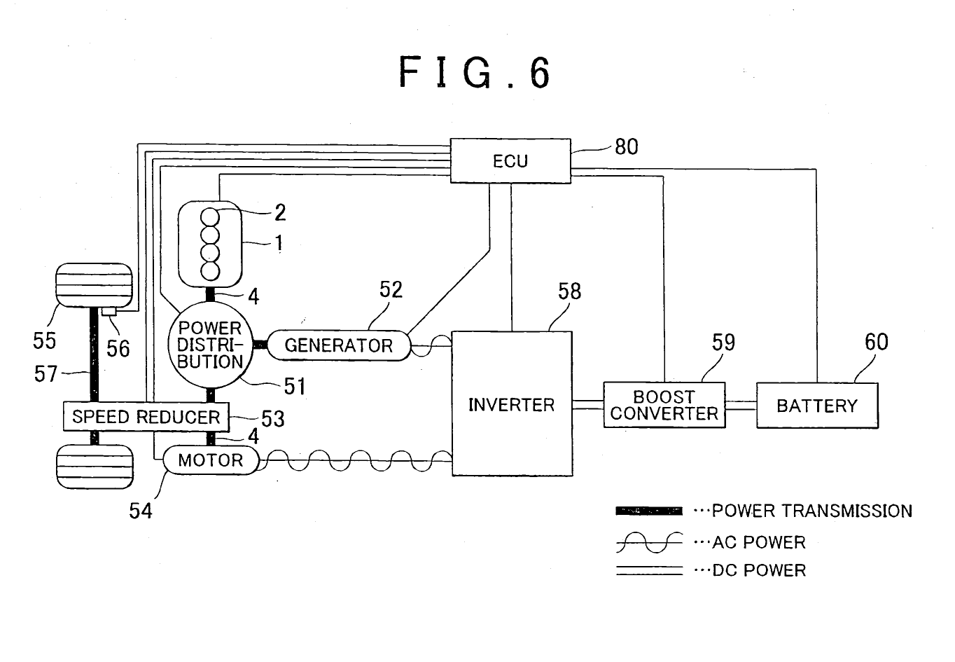

Next, referring to FIGS. 6 to 9, Embodiment 2 of the present invention will be described. The independent exhaust engine 1 according to Embodiment 1 mentioned above can be mounted in a hybrid vehicle shown in FIG. 6. FIG. 6 is a diagram illustrating the configuration of a hybrid vehicle according to Embodiment 2 of the present invention. The hybrid vehicle shown in FIG. 6 includes, in addition to the above-mentioned engine 1 serving as a drive source, a motor generator (hereinafter, referred to as “generator”) 52 and a motor generator (hereinafter, referred to as “motor”) 54 each serving as other drive sources.

As shown in FIG. 6, the hybrid vehicle includes a triaxial power distribution mechanism 51. The power distribution mechanism 51 is a planetary gear mechanism described later. In addition to the crankshaft 4 of the engine 1, the generator 52 and the motor 54 are connected to the power distribution mechanism 51. Also, a speed reducer 53 is connected to the power distribution mechanism 51. A rotating shaft 57 of a drive wheel 55 is connected to the speed reducer 53. The drive wheel 55 is provided with a wheel speed sensor 56. The wheel speed sensor 56 is configured to detect the rpm or rotational speed of the drive wheel 55.

The generator 52 and the motor 54 are connected to a common inverter 58. The inverter 58 is connected to a boost converter 59, and the boost converter 59 is connected to a battery 60. The boost converter 59 converts a voltage (for example, DC of 201.6 V) of the battery 60 into a high voltage (for example, DC of 500 V). The inverter 58 converts a high DC voltage boosted by the boost converter 59 into an AC voltage (for example, AC of 500 V). The generator 52 and the motor 54 exchange electric power with the battery 60 via the inverter 58 and the boost converter 59.

As shown in FIG. 6, the ECU 80 is connected with, in addition to the engine 1 mentioned above, the power distribution mechanism 51, the generator 52, the speed reducer 53, the motor 54, the wheel speed sensor 56, the inverter 58, the boost converter 59, the battery 60, and the like. The ECU 80 controls the amounts of drive or power generation of the generator 52 and the motor 54. Also, the ECU 80 acquires the state of charge SOC of the battery 60.

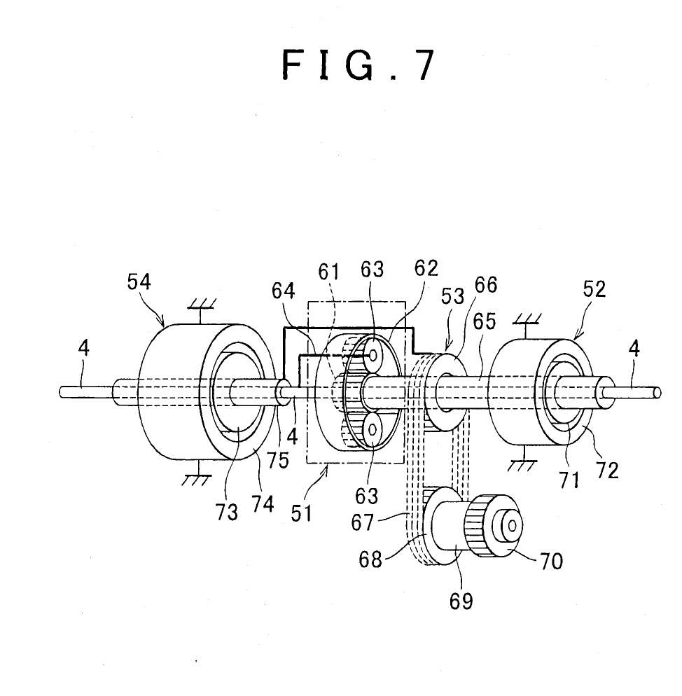

FIG. 7 is a perspective view showing the main-portion configuration of a drive mechanism in the hybrid vehicle shown in FIG. 6. As shown in FIG. 7, the power distribution mechanism 51 includes a sun gear 61, a ring gear 62, a plurality of pinion gears 63, and a carrier 64. The sun gear 61 as all outer gear is fixed to a hollow sun gear shaft 65. The crankshaft 4 of the engine 1 extends through this hollow portion of the sun gear shaft 65. The ring gear 62 as an inner gear is arranged concentrically with the sun gear 61. The plurality of pinion gears 63 are arranged so as to mesh with both the sun gear 61 and the ring gear 62. The plurality of pinion gears 63 are rotatably held by the carrier 64. The carrier 64 is coupled to the crankshaft 4. That is, the power distribution mechanism 51 is a planetary gear mechanism that attains differential actions with the sun gear 61, the ring gear 62, and the pinion gears 63 as rotational elements.

The speed reducer 53 has a power take off gear 66 for power take-off. The power take off gear 66 is coupled to the ring gear 62 of the power distribution mechanism 51. Also, the power take off gear 66 is coupled to a power transmission gear 68 via a chain 67. The power transmission gear 68 is coupled to a gear 70 via a rotating shaft 69. The gear 70 is coupled to a differential gear (not shown) that rotates the rotating shaft 57 of the drive wheel 55.

The generator 52 has a rotor 71 and a stator 72. The rotor 71 is provided to the sun gear shaft 65 that rotates integrally with the sun gear 61. The generator 52 is configured so as to be driven as an electric motor for rotating the rotor 71, and also as a generator for generating an electromagnetic force through rotation of the rotor 71. Also, the generator 52 can serve as a starter at engine start-up.

The motor 52 has a rotor 73 and a stator 74. The rotor 73 is provided to a ring gear shaft 75 that rotates integrally with the ring gear 62. The motor 54 is configured so as to be driven as an electric motor for rotating the rotor 73, and also as a generator for generating an electromagnetic force through rotation of the rotor 73.

The power distribution mechanism 51 can distribute power from the engine 1 input from the carrier 64 to the sun gear 61 connected to the generator 52, and to the ring gear 62 connected to the rotating shaft 75, in accordance with their gear ratio. Also, the power distribution mechanism 51 can integrate power from the engine 1 input from the carrier 64, and power from the generator 52 input from the sun gear 61, and outputs the integrated power to the ring gear 62. Also, the power distribution mechanism 51 can integrate power from the generator 52 input from the sun gear 61, and power input from the ring gear 62, and outputs the integrated power to the carrier 64.

The ECU 80 computes a requested output (or requested torque) for the vehicle as a whole, on the basis of the rotational speed of the drive wheel 55 detected by the wheel speed sensor 56, the accelerator operation amount AA detected by the accelerator operation amount sensor 20, and the like. To secure this requested output for the vehicle as a whole, the ECU 80 distributes the drive force between the engine 1, the generator 52, and the motor 54 while taking the state of charge SOC of the battery 60 into consideration. That is, the ECU 80 determines an operating point of the engine 1 along an iso-output curve described later, and computes requested outputs for the generator 52 and the motor 54.

In Embodiment 1 mentioned above, if there is an acceleration request after completion of the warm-up of the starting catalyst 40, when the exhaust gas temperature Tex is low, the first exhaust valve Ex1 is opened to a full lift and the second exhaust valve Ex2 is opened to an intermediate lift. At this time, as compared with when the second exhaust valve Ex2 is fully closed, the boost pressure becomes low, so the output also becomes low. That is, priority is given to preventing deactivation of the starting catalyst 40 while permitting some drop in output.

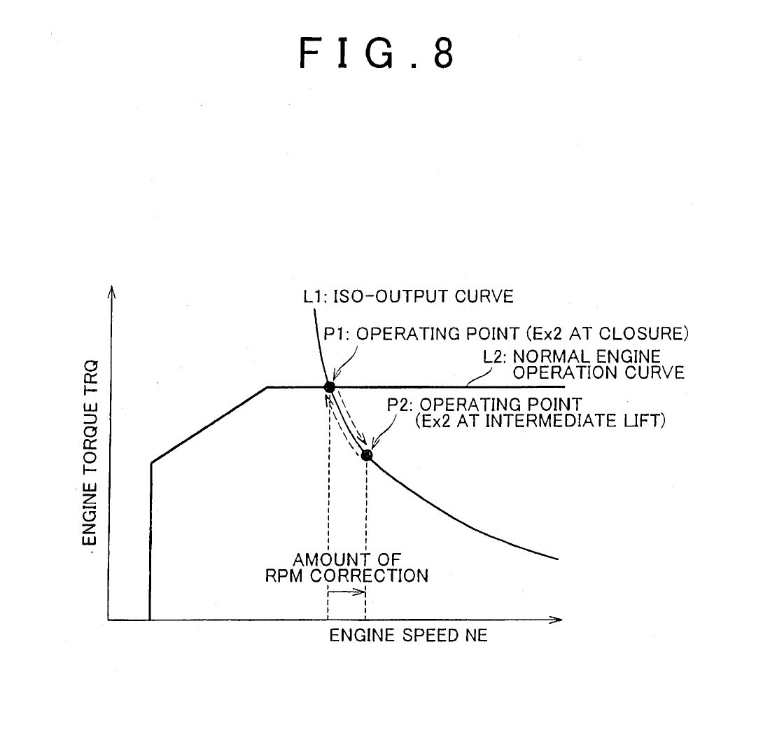

Accordingly, in Embodiment 2, the problem of a drop in output when the second exhaust valve Ex2 is opened to an intermediate lift is overcome in the manner described below. FIG. 8 is a diagram illustrating an engine operating point correction when the second exhaust valve Ex2 is at an intermediate lift in Embodiment 2. FIG. 8 shows an iso-output curve L1 of the hybrid vehicle, and a normal engine operation curve L2. Normally, when there is an acceleration request, an operating point P1 on the engine operation curve L2 is selected. In Embodiment 2, as described above with reference to Embodiment 1, if the exhaust gas temperature Tex is equal to or lower than the predetermined value Tth, the second exhaust valve Ex2 is opened to an intermediate lift. As a result, in comparison to when the second exhaust valve Ex2 is fully closed, the boost pressure drops, resulting in a drop in output.

Accordingly, in Embodiment 2, when the second exhaust valve Ex2 is opened to an intermediate lift as shown in FIG. 3B, the engine operating point is corrected to the high rotation side on the iso-output curve. More specifically, when the second exhaust valve Ex2 is opened to an intermediate lift, the engine operating point P1 on the iso-output curve L1 shown in FIG. 8 is corrected to an engine operating point P2. Since the engine speed NE is high at the engine operating point P2 relative to that at the engine operating point P1, the exhaust gas temperature Tex rises. Thus, exhaust energy supplied to the turbine 24b increases, so the turbo rpm increases, thereby making it possible to raise the boost pressure. As a result, even though the second exhaust valve Ex2 is opened to an intermediate lift, an output equivalent to that when the second exhaust valve Ex2 is fully closed can be obtained. Further, the warm-up of the first exhaust passage 32 and the turbine 24b can be promoted, thus enabling transition to the fully closed state of the second exhaust valve Ex2 shown in FIG. 3C at an early stage.

When the exhaust gas temperature Tex becomes higher than the predetermined value Tth, the second exhaust valve Ex2 is closed (fully closed), so the engine operating point P2 on the iso-output curve L1 is returned to the engine operating point P1 on the normal engine operation curve L2.

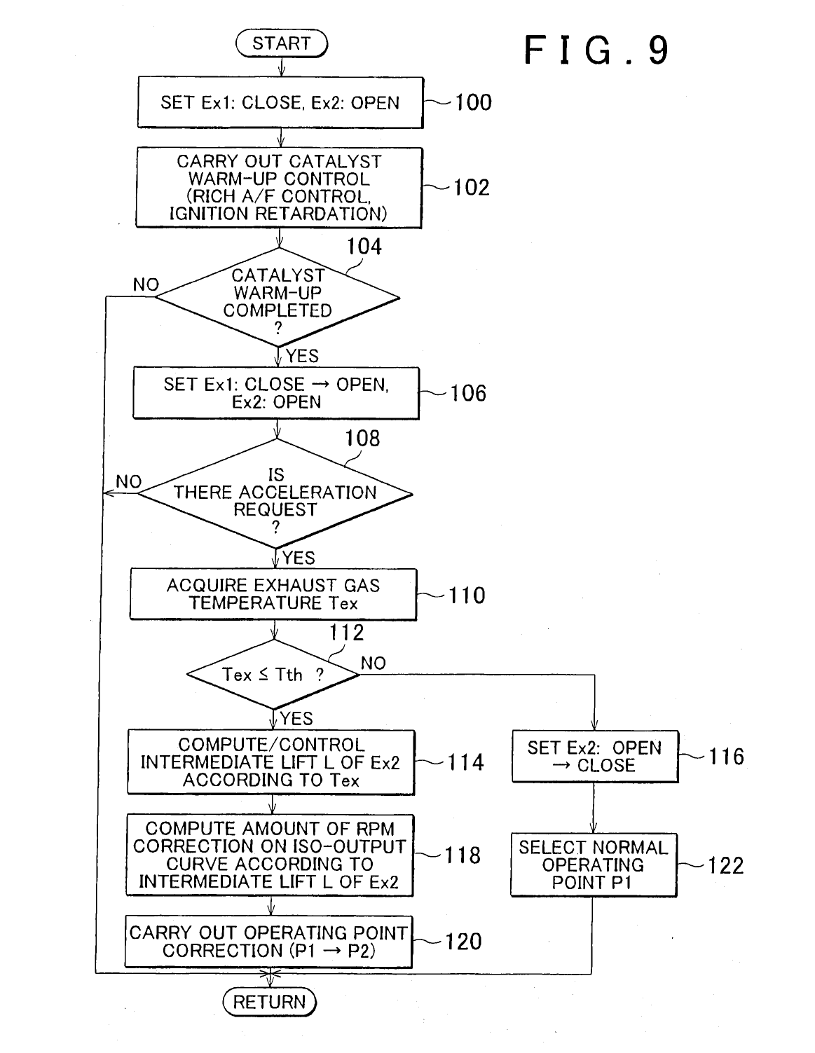

FIG. 9 is a flowchart showing a routine executed by the ECU 80 in Embodiment 2. The routine shown in FIG. 9 is activated at engine start-up, for example.

According to the routine shown in FIG. 9, first, the steps up to the determination processing in step 112 are executed in the same manner as in the routine shown in FIG. 5. If it is determined in this step 112 that the exhaust gas temperature Tex is equal to or lower than the predetermined value Tth, as in the routine shown in FIG. 5, the intermediate lift L of the second exhaust valve Ex2 according to the exhaust gas temperature Tex is computed, and the variable valve mechanism 31 is controlled (step 114).

Thereafter, an amount of rpm correction on the iso-output curve L1 according to the intermediate lift L computed in step 114 mentioned above is computed (step 118). In this case, the larger the intermediate lift L, the smaller the exhaust energy supplied to the turbine 24b. Accordingly, in this step 118, the amount of rpm correction is computed to be larger as the intermediate lift L becomes larger. Thus, as the intermediate lift L becomes larger, the engine operating point P2 is corrected to the higher rotation side, so the exhaust gas temperature can be raised.

Next, the engine operating point is corrected to the high rotation side by the amount of rpm correction computed in step 118 mentioned above (step 120). In this step 120, for example, through control of the power distribution mechanism 51, the operating point P1 shown in FIG. 8 is corrected by the amount of rpm correction, to the engine operating point P2 on the high rotation side. Thereafter, the present routine is terminated temporarily.

If, after the present routine is activated next time, it is determined in step 112 mentioned above that the exhaust gas temperature Tex is higher than the predetermined value Tth, as in the routine shown in FIG. 5, the second exhaust valve Ex2 is fully closed (closed) (step 116). That is, it is determined that since the warm-up of the first exhaust passage 32 and the turbine 24b has been completed, the possibility of deactivation of the starting catalyst 40 is now very low, so the second exhaust valve Ex2 is fully closed. Then, a drop in output due to the second exhaust valve Ex2 being at an intermediate lift does not occur, so the engine operating point P1 on the normal engine operation curve L2 is selected (step 122). In this step 122, the power distribution mechanism 51 is controlled so as to attain the engine operating point P1. Thereafter, the present routine is terminated.

As described above, according to the routine shown in FIG. 9, if there is an acceleration request after completion of catalyst warm-up, when the exhaust gas temperature Tex is equal to or lower than the predetermined value Tth, the lift of the second exhaust valve Ex2 is controlled to the intermediate lift L. Thereafter, the engine operating point on the iso-output curve is corrected to the high rotation side. Therefore, deactivation of the starting catalyst 40 can be prevented, and a drop in output can be prevented for enhanced acceleration performance. Further, by correcting the engine operating point to the high rotation side, the exhaust gas temperature can be raised, thereby making it possible to promote the warm-up of the first exhaust passage 32 and the turbine 24b. Since the second exhaust valve Ex2 can be thus fully closed at an early stage, it is possible to enhance the acceleration performance. Also, as the intermediate lift L of the second exhaust valve Ex2 becomes larger, the engine operating point is corrected to the higher rotation side. Therefore, even when the intermediate lift L of the second exhaust valve Ex2 is large, it is possible to prevent a drop in output, and promote the warm-up of the first exhaust passage 32 and the turbine 24b.

It should be noted that in Embodiment 2, the generator 52 and the motor 54 may each be regarded as the “electric motor” according to the present invention. Also, in Embodiment 2, the “control means” according to the present invention, and the “exhaust gas temperature acquiring means” according to the present invention are realized by the ECU 80 executing the processing of steps 100, 112, 114, 116, and the processing of step 110, respectively.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

1. A control system for a vehicle having an internal combustion engine with a turbocharger, comprising:
a first exhaust valve that opens and closes a first exhaust passage leading to a turbine of the turbocharger;
a second exhaust valve that opens and closes a second exhaust passage leading to downstream of the turbine;
a variable valve mechanism that makes a lift of the second exhaust valve variable;
a catalyst arranged downstream of a junction of the first exhaust passage and the second exhaust passage; and
a control portion that controls opening and closing of the first and second exhaust valves, wherein
when switching from a first state in which the first exhaust valve is closed and the second exhaust valve is opened, to a second state in which the first exhaust valve is opened and the second exhaust valve is closed, the control interposes a third state in which the first exhaust valve is opened and the second exhaust valve is opened to an intermediate lift within a predetermined range, between the first state and the second state, by using the variable valve mechanism.

2. The control system according to claim 1, further comprising
an exhaust gas temperature acquiring portion that acquires temperature of exhaust gas that flows into the catalyst, wherein
the control portion controls the first and second exhaust valves to the third state when an exhaust gas temperature acquired by the exhaust gas temperature acquiring portion is equal to or lower than a predetermined value.

3. The control system according to claim 2, wherein when the exhaust gas temperature is equal to or lower than a predetermined value, the control portion sets the intermediate lift of the second exhaust valve smaller as the exhaust gas temperature becomes higher.

4. The control system according to claim 1, further comprising:
an electric motor as a drive source other than the internal combustion engine; and
an operating point control portion that controls an operating point of the internal combustion engine on an iso-output curve along which a total output of the internal combustion engine and the electric motor is constant, wherein
the operating point control portion controls the operating point to a higher rotation side when the first and second exhaust valves are controlled to the third state by the control portion, than when the first and second exhaust valves are controlled to the second state.

5. The control system according to claim 4, wherein when the first and second exhaust valves are controlled to the third state by the control portion, the operating point control portion controls the operating point to a higher rotation side as the intermediate lift of the second exhaust valve becomes larger.

6. A control method for a vehicle having an internal combustion engine with a turbocharger, comprising:
closing a first exhaust valve that opens and closes a first exhaust passage leading to a turbine of the turbocharger, and opening a second exhaust valve that opens and closes a second exhaust passage leading to downstream of the turbine;
opening the first exhaust valve, and opening the second exhaust valve to an intermediate lift within a predetermined range by using a variable valve mechanism that makes a lift of the second exhaust valve variable; and
opening the first exhaust valve and closing the second exhaust valve, wherein
a catalyst is arranged downstream of a junction of the first exhaust passage and the second exhaust passage.
